(19) United States
(12) Patent Application Publication
(10) Pub. No.: US 2004/0079642 A1
(43) Pub. Date: Apr. 29, 2004

(54) Method and device for recovering metals by means of pulsating cathode currents also in combination with anodic coproduction processes

(76) Inventors: Wolfgang Thiele, Eilenburg (DE); Knut Wildner, Eilenburg (DE); Gerd Heinze, Eilenburg (DE)

Correspondence Address: Lerner & Greenberg, PO Box 2480, Hollywood, FL, 33020-2480, US

(21) Appl. No.: 10/471,690

(22) PCT Filed: Mar. 11, 2002
(86) PCT No.: PCT/EP02/02652

(30) Foreign Application Priority Data
Mar. 12, 2001 (DE) 101 12 075.3

(51) Int. Cl. C25D 5/18

(52) U.S. Cl. 205/104

(57) ABSTRACT

The invention aims to achieve effective recovery of metals from process solutions and effluents by means of pulsating cathode currents, preferably with coupled anodic processes.

To precipitate metals by means of direct current in electrolysis cells which are undivided or are divided by separators, the pulsating cathode currents are generated by the anodes being divided into stationary strips past which the undivided cathode surface is guided. The current pulses formed on the cathode surface as a result can be varied in form and frequency by the arrangement of the anode strips and by current diaphragms. An apparatus with rotating cylinder cathodes and concentrically arranged anode pockets, the side walls of which function as current diaphragms and flow breakers, is preferred. Not only does the invention allow efficient recovery of metals, but also it allows coupling to various anode processes, e.g. for regeneration of peroxide sulfates and for breaking down inorganic or organic pollutants by oxidation.

The invention relates to a method and an apparatus for effective cathodic precipitation and recovery of metals from process solutions and effluents, e.g. from exhausted pickling solutions, preferably also in combination with anodic oxidation processes.

When metals are being recovered from process solutions and effluents, problems frequently arise from the fact that the metals can only be precipitated at the cathodes of the metal recovery cells with insufficient current efficiencies and/or in pulverulent form with poor adhesion. If electrolysis cells with plate cathodes, e.g. metal sheets or expanded metal plates, are used, it is therefore often only possible to use very low current densities, with the result that the electrode surface areas required and therefore the procurement costs increase while the efficiency is reduced. To improve mass transfer and therefore current efficiency and/or current density, it has also been proposed, inter alia, to use electrolysis cells with rotating cylinder cathodes, as described, for example, in CH 685015 A5 or DE 29512905.0. In this context, the aim was always, in order to achieve a uniform current density distribution on the cathode, to distribute the stationary anodes, e.g. in the form of expanded metals, as uniformly as possible around the rotating cathodes, also in order to keep the cell voltage as low as possible. Circumferential speeds of between 2 and 5 m/s are set at these rotating cathodes in order to accelerate the mass transfer and in this way to obtain compact metal deposits with good adhesion and high current efficiencies.

U.S. Pat. No. 4,530,748 proposes a further possible way of increasing the mass transfer when using a rotating cylinder cathode. For this purpose, at least one perpendicular anode is arranged obliquely with respect to the cathode, in such a way that the gap which results between the cathode and each anode narrows in the direction of rotation of the cathode, in a similar way to a vertically elongate venturi. The narrowest point of the vertical gap not only has the highest current loading on account of the distance between the anode and the cathode being at its minimum, but also has the maximum turbulence on account of the venturi effect and therefore also has a favorable mass transfer. However, this arrangement of the anodes is disadvantageous in applications in which the relatively large current density differences between the anode edges which are at the shortest distance from the cathode and the anode edges which are at the maximum distance from the cathode have unfavorable effects on the current efficiency of the anode process. Also, an arrangement of this type is altogether unsuitable for divided electrolysis cells and is therefore also not intended for this application.

Despite the known possibilities for increasing the mass transfer at rotating cylinder cathodes which have been presented, the maximum possible cathodic current density with a low final concentration of the metal which is to be depleted remains limited if a coating which still adheres securely is to be achieved. For example, the current densities employed in practice at the rotating cathodes, depending on the type of metal to be precipitated, the composition of the catholyte solution and the desired final concentration, are generally between 2 and at most 5 A/dm².

It is also known from the electroplating sector that the use of a pulsating direct current may, depending on the metal-electrolyte system which is present, be associated with the following benefits (Pulse Plating, Ed. J. C. Puppe, F. Leamm, Eugen Leutze Verlag 1990):

Considerable improvement to the properties of the precipitated metal covering, in particular on account of a finer-grained structure and a reduced roughness.

Reduction in the tendency to form dendrites.

Increase in the precipitation rate/current density which can be achieved.

A certain amount of coprecipitation of baser metals can be achieved, unlike with DC precipitation (important for alloy precipitation).

With specific metal-electrolyte systems, the current efficiency may be increased by suppression of secondary reactions (e.g. in the case of precipitation of rhenium).

The form of pulses used in the pulsating direct current ranges from sinusoidal to square-wave. Steep flanks of the pulse with brief current interruptions have a particularly favorable effect. A brief pulse reversal may also be highly advantageous for specific applications. The result is a more uniform layer thickness distribution, since metals which precipitate to an increased extent at corners and edges (e.g. in the form of dendrites) are also preferably dissolved again by the subsequent anodic pulse.

Therefore, it can be assumed that the precipitation of metals can be leveled out more successfully by using the pulsating direct current. The application of this principle also promises better adhesion of the precipitated metal coating in the limit range of low residual concentrations for recovery of metals. This would make it possible to achieve a higher mean current density while achieving the same level of metal depletion or to attain a greater level of depletion if the same current density is maintained. However, the additional outlay on apparatus required to realize a pulsating direct current is a not insignificant factor in connection with the economic viability of the recovery of metals. Particularly in the case of rectifiers with square-wave pulses and with pulse reversal, the procurement costs may amount to three to five times those of conventional rectifiers.

The pulsating electrolysis current may also have a disadvantageous effect on the anode reaction or on the anode itself. Since the counterelectrodes are exposed to the same current pulses, the corrosion resistance of the anodes may be reduced by the pulsating current. Corrosion-inhibiting oxide layers which form under a steady-state anodic load are destroyed or at least damaged (for example platinum) by the pulsation and in particular by the pulse reversal. However, this phenomenon may also damage the protective oxide layers which are formed in the case of what are known as the valve metals titanium, niobium, tantalum, zirconium.

In many cases, when recovering metals from process solutions, it is also endeavored to utilize the anode process as part of a combination method. This generally requires a high anodic potential, e.g. for breaking down organic complexing agents or cyanides by oxidation. In this context, a pulsating anodic electrolysis current has an unfavorable effect on the anodic current efficiencies which can be achieved in that, for example, the oxide layers on precious metal anodes, which are required for a high oxygen overvoltage and therefore a high oxidation potential, are attacked. This is to be expected, for example, for the anodic oxidation of cyanides during the treatment of cyanide-based metal solutions or during the anodic reoxidation of peroxodisulfate pickles at platinum anodes combined, at the same time, with cathodic recovery of metals. In the latter case, it is known that only after several hours of anodic polarization have the stationary oxide covering layers formed to a sufficient extent for it to be possible to attain maximum current efficiencies. Current interruptions and in particular the pulse reversal inevitably lead to losses in efficiency.

Therefore, the present invention is based on the object of enabling the advantageous effects of a pulsating direct current which have been presented to be utilized also for the recovery of metals from process solutions and effluents without at the same time having to accept the drawbacks which have been presented in connection with the increased outlay involved in generating a pulsating direct current and the adverse effects on the anodes and/or, in the case of combination processes, on the sequence of the anode reactions.

In accordance with the invention, this objective is achieved by a method as claimed in claims 1 to 3 and by an apparatus for preferably carrying out the method as claimed in claims 4 to 15 and preferred uses of the method as claimed in claims 16 to 21. The electrolysis is carried out by means of an unpulsed direct current in an electrolysis cell equipped with cathodes and anodes, it being possible for the cathodes and anodes to be divided by separators, and the pulsating cathode currents being generated by the anodes being divided into strips with a width of 2 to 100 mm and, individually or combined in groups, being arranged in a stationary position parallel or concentrically to the cathode surface, while the undivided cathode surface is guided past the anode strips at a rate of 1 to 10 m/s in a direction which is perpendicular to their longitudinal extent, and the distance between the side walls of two adjacent individual anode strips or the groups of anode strips amounts to at least 1.5 times the perpendicular distance between the center of the individual anode strips or the group of anode strips and the cathode. In this context, the parallel arrangement of the anode strips with respect to the cathode surface applies to a cathode which is moved linearly, while the concentric arrangement applies to circular, rotating cathodes.

On account of this procedure, each point of the moving cathode surface successively passes through areas with a high current density and a low current density, with a current density maximum at the shortest distance from the next anode strip and a current density minimum at the greatest distance from the next anode strip.

To realize this inventive method, it is possible for the undivided cathode surface to be guided past the stationary anode, which has been divided into individual electrode strips, either in the form of bands or wires in a linear movement or in the form of cylinders, cones or disks in a rotary movement.

The anode strips may either be individually distributed uniformly over the entire area of the anode or may be combined in groups with uniform, shorter distances within the groups and greater distances between the groups. It has been found that the minimum distance between the individual anode strips or the groups of anode strips must be 1.5 times the perpendicular distance between anode and cathode in order to achieve a pulsating action of sufficient magnitude.

The alternative or additional arrangement of internals for potential shielding between individual anode strips or anode strips which have been combined in groups, as so-called current diaphragms, has proven particularly advantageous.

For this purpose, the anode strips or the groups of anode strips are preferably arranged in holders with edges which project laterally in the direction of the moving cathode, referred to below as pockets.

The current diaphragms in combination with the minimum distances make it possible to ensure that areas in which the current density drops steeply from its maximum to approximately zero are formed on the cathode moving past between the individual anode strips or the anode strips which have been combined in groups. This makes it easy to realize a current density profile with steep pulse flanks on the cathode surface, approximating to the particularly effective square-wave pulses. At the same time, these potential-shielding internals serve as flow breakers and thereby increase the turbulence at the cathode surface moving past, with the result that the mass transfer to and from the cathode surface is additionally accelerated.

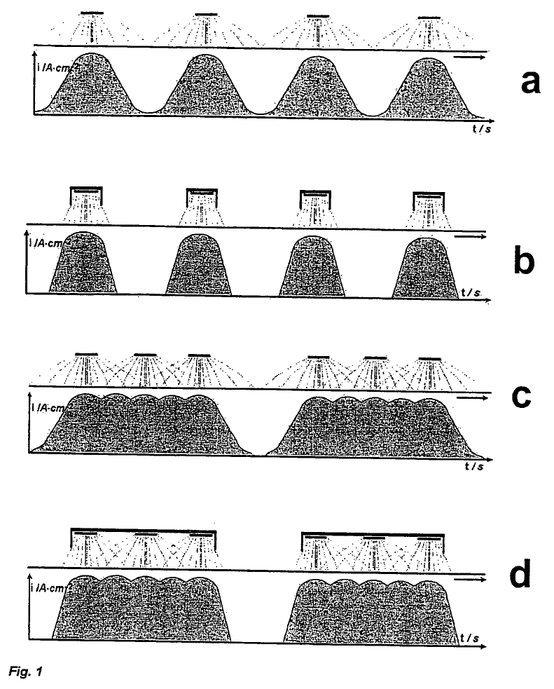

FIG. 1 diagrammatically depicts, by way of example, various geometric arrangements and the current density pulses which are formed therefrom on the cathode. The illustration applies to the case of stationary anode strips which are oriented parallel to the cathode surface and which the cathode moves past linearly. In this context, it should be taken into account that the current density distribution is known to be dependent not only on the geometry of the electrode arrangement but also on the electrolyte composition (dispersing capacity) and on the electrode potentials. Therefore, this illustration should and can only be used to clarify the basic principle of the invention. The figure illustrates:

a) Geometry and current density-time function for the arrangement of individual anode strips, the distance between which is 1.5 times the anode-cathode distance.

b) Geometry and current density-time function as in a, but with the individual strips arranged in pockets, the side walls of which function as current diaphragms and current breakers.

c) Geometry and current density-time function for groups of in each case three anode strips in which the distance within the group is equal to the anode-cathode distance, while the distance between the groups amounts to more than 1.5 times the anode-cathode distance.

d) Geometry and current density-time function as in c, but with the groups of anode strips arranged in pockets, the side walls of which function as current diaphragms and flow breakers.

It may also be advantageous for no current to be allowed to flow on the cathode which is moving past for a prolonged period. This can easily be achieved by setting significantly greater distances between some groups of anode strips than between the others.

The combination of the relative movement between cathode and anode, which is known per se to increase mass transfer, with the dividing of the anode area into individual strips in accordance with the invention, and the arrangement of potential-shielding and turbulence-increasing internals results in particularly effective cathodic recovery of metals without adverse effects on the anode reaction and the durability of the anodes themselves.

The method according to the invention can be carried out in various design variants of undivided or divided electrolysis cells. It is particularly advantageous to use an electrolysis cell (apparatus) with rotating cylinder cathodes.

The apparatus described in claims 6 to 16 comprises one or more rotating cylinder cathodes arranged in a housing. Perpendicular, 2 to 100 mm wide anode strips are arranged concentrically around the cylinder cathodes, individually or combined in groups, in anode pockets. The distance between the individual anode pockets is at least 1.5 times the perpendicular distance between the anode strips and the cathode. The side walls of the anode pockets simultaneously serve as current diaphragms and flow breakers with the following effects:

as current diaphragms they effect potential shielding in order for the cathodic current pulses which form on the cathode surface to have steep flanks,

as flow breakers they simultaneously increase turbulence at the cathode surface moving past in order to accelerate the mass transfer.

It has been found that these side walls of the anode pockets are sufficiently effective for the purposes presented if, starting from the plane of the anode strips, they extend over at least ¼ of the perpendicular distance between the anode strips and the cathode.

In the case of the undivided cells, the anode pockets are open on the side facing the cathode. In the case of divided cells, the anode pockets are equipped with separators and separate feeds and discharges for the anolyte solutions. They therefore form individual anode spaces through which the anolyte flows and which are closed off in a liquid-tight and gas-tight manner with respect to the catholyte. This division into individual anode pockets brings with it a number of advantages over the continuous anode spaces which are otherwise customary in the case of divided electrolysis cells with rotating cylinder cathodes. With regard to the independent setting of the anodic current density and the residence time in the anode space, the structural design of the anode pockets results in far greater possible variations than with the continuous anode space that has hitherto been customary. In this way, it is possible to realize extremely low residence times combined, at the same time, with high anodic current densities, as required, for example, for the anodic regeneration of peroxodisulfate pickling solutions.

The division of the overall anode space into individual anode pockets is moreover very useful for servicing and maintenance purposes. Individual anode pockets can easily be exchanged in the event of defects at the anodes or the separators without the remaining anode pockets having to be dismantled.

A further advantage of the division into individual anode pockets consists in the fact that it is possible for a plurality of anode pockets to be hydrodynamically connected in series. This results in the flow characteristics of a reactor cascade, which in some applications contributes to achieving a higher current efficiency of the anode reaction.

For some applications, it has proven advantageous for relatively large sections of the rotating cathode at which the current density is near zero to be passed through. This can be achieved in a simple way by an uneven distribution of the anode pockets around the cylinder cathode, with some distances between the anode pockets amounting to a multiple of the distances between the other anode pockets. For example, it is possible for some anode pockets to be omitted from an otherwise symmetrical distribution.

Particularly in the case of electrolysis cells with a relatively high current capacity, it has proven advantageous for the drive to be arranged in a space which is separated off in a liquid-tight and gas-tight manner within the electrolyte vessel. This allows the drive-cylinder cathode system to be of very compact design, so that there is no need for relatively long shafts and the associated problems with regard to their additional bearing and sealing.

A cooler is often required for sufficient dissipation of the current heat, which cooler may be arranged externally in an electrolyte circuit or internally directly in the electrolyte vessel. The internal arrangement has the advantage that there is no need for external circulation of electrolyte.

It is advantageous to use a frequency-controlled drive in particular for relatively large and heavy cylinder cathodes. This not only makes it possible to start up the cell without jerks and with the rotational speed increasing slowly, but also enables the working rotational speed to be varied and optimally matched to the particular electrolysis process.

The cylinder cathode preferably consists of special steel. A slightly conical design has an advantageous effect on the removal of the precipitated metal. To achieve a uniform current density distribution over the height of the cylinder even in the case of a conical cylinder cathode, the anodes or the anode pockets are arranged with an inclination matched to the cone of the cylinder cathode.

The anode strips preferably consist of valve metals titanium, niobium, tantalum or zirconium coated with precious metals, precious metal mixed oxides or with doped diamond. The separators used are ion exchange membranes or microporous plastic films.

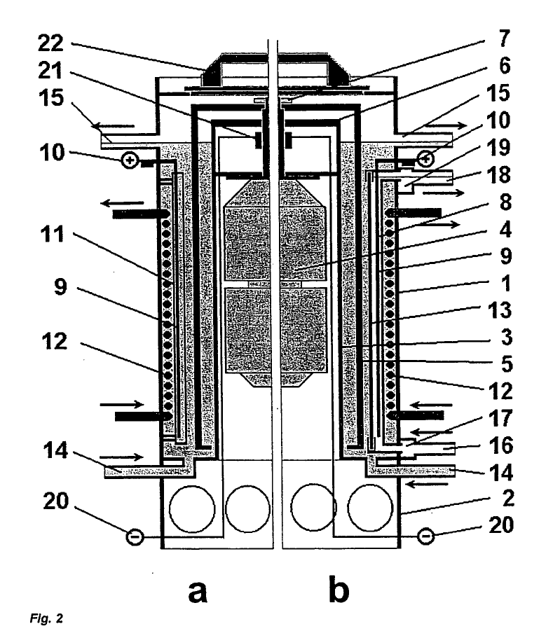

FIG. 2 shows a preferred embodiment of the proposed electrolysis cell with rotating cylinder cathode in the form of two differently equipped half-cells. The left-hand half-cell a corresponds to an undivided cell variant, while the right-hand half-cell b corresponds to a cell variant which is divided by separators. The electrolyte vessel 1 is positioned on a supporting tube 2 with ventilation openings. A protected interior in which the drive 4 is located is formed by an inner protective tube connected to the base of the electrolyte vessel in a liquid-tight manner. The drive shaft is guided in a liquid-tight and gas-tight manner through the interior cover 6 and is connected to the cylinder cathode 5 using a securing element 7. In the case of the undivided cell, the strip anodes are arranged and held in the anode pockets 11 which are secured to the wall and are open toward the cathode side. The current supply conductors 10 to the anodes are guided laterally through the vessel wall. In the case of the divided cell, the strip anodes 9 are arranged in the anode pockets 8, which are closed on all sides.

That side of the anode pockets which faces the cathode contains the separators 13. While the inlet and outlet for the catholyte lead directly through the wall for the electrolyte vessel, the anolyte is distributed to the individual anolyte inlets 16 via an outer ring line 17 and is discharged again via the anolyte outlets 18 and a ring line 19. The cooler 12 is arranged between the wall for the electrolyte vessel and the anode pockets. The current supply 20 to the cylinder cathode is effected by means of the sliding contacts 21. The electrolyte vessel is closed off by the cover 22.

The cylinder cathode rotates at a rotational speed which is such that a circumferential speed of between 2 and 10 m/s results. The apparent pulsation frequency which can be achieved at the cathode surface is dependent on this circumferential speed and the number of anode pockets arranged around the rotating cylinder cathode. Given a uniform distribution, the apparent pulsation frequencies given in Table I result as a function of the number of anode pockets.

By selecting the arrangement and the geometric configuration of the anode pockets in conjunction with the circumferential speed on the rotating cathode, it is possible to vary the frequency and form of the current density pulses which form on the cathode surface within wide limits and to suitably match them to the requirements of the cathode process in question. Compared to electrolysis by means of pulsating direct current with a stationary cathode, the high relative velocity between the rotor and the electrolyte and also the turbulence-increasing internals additionally have an advantageous effect on the mass transfer and therefore on the consistency of the metal precipitation. Therefore, with the electrolysis cell in accordance with the present invention, it is easy to achieve at least as good positive effects on the cathodic metal precipitation as can be achieved for certain electroplating applications only by means of a pulsating direct current and the complex electronic circuits required to generate such a current.

Moreover, it has surprisingly been found that with the method according to the invention and the electrolysis cell which is preferably to be used for this method, in the case of the recovery of metals from exhausted pickling solutions, e.g. the recovery of copper from a solution which still contains pickling agent residues (peroxodisulfate, hydrogen peroxide), it is possible to achieve similarly positive effects with regard to the metal precipitation as are otherwise only known in the case of pulse plating with pulse reversal. In the cathode regions in which, on account of there being a sufficiently great distance between the anode pockets and on account of almost complete shielding of the current lines by the current diaphragms, the current density is virtually zero, pickling agent which is still present passes to the cathode surface. There, copper particles which are grown on in the form of very fine particles, e.g. dendrites, can be completely or partially dissolved again by the oxidizing agent which is still present. This is practically the same effect which is achieved in the case of pulse plating with pulse reversal by briefly reversing the polarity of the electrolysis current. In that case, partial redissolution is effected by brief anodic loading. In this case, the brief “apparent” disconnection of the electrolysis current leads to partial redissolution of metal particles by the oxidizing agent which remains. Unlike in the case of pulse plating with pulse reversal, however, there is in this case no current efficiency loss caused by the redissolution of metal which has already been precipitated. Rather, the redissolution leads to an equivalent breakdown of the excess oxidizing agent. This then no longer has to be cathodically reduced, and consequently the sum of the current efficiencies of the metal precipitation and the reduction of the excess oxidizing agent therefore remains unchanged, whereas in the case of pulse plating with pulse reversal there is a permanent reduction in the current efficiency.

Strip anodes have already been used in some of the previously known electrolysis cells with rotating cathodes for recovery of metals. By way of example, perpendicular bars or sheet-metal segments have been used for anode materials which are not suitable for conventional use as an expanded grid, e.g. carbon or lead. However, this was not with a view to generating a pulsating cathode current in the sense of the present invention. Therefore, with these cells there was also no focus on effecting pronounced pulsation with steep pulse flanks by selecting a suitable distance ratio and by using potential-shielding internals. The result was at best an unintentional, slight pulsation caused by superimposition of the current density profiles of adjacent anodes, without significant positive effects on the consistency of the metal precipitation.

The novel method and the apparatus for recovering metals by means of pulsating cathode currents in accordance with the present invention not only make it possible to recover metals more efficiently than with the known methods and apparatus presented in the introduction, but also make it possible to achieve novel method combinations with anode processes and/or to carry out known combination processes more economically. All metals which are customary in surface treatment, such as copper, nickel, iron, cobalt, zinc, cadmium, chromium, lead, tin, rhenium, silver, gold, platinum and other precious metals, can be cathodically recovered. While the more precious metals can be recovered from strongly acidic solutions, in the case of some metals it is necessary to set and maintain a lower acid content. In this case, when using undivided or divided electrolysis cells in batch or continuous operation, electrolysis can be carried out at mean cathode current densities of 2 to 10 A/dm², making it possible to achieve depletion levels down to as little as 10 mg/l with even more compact precipitation of the metals in question.

In the case of recovery of metals from etching or pickling solutions, the residual oxidizing agents, predominantly peroxomonosulfates and peroxodisulfates (referred to below as peroxosulfates) and hydrogen peroxide, are additionally reduced cathodically. This makes it possible to prevent having to destroy these oxidizing agents by adding suitable reducing agents during effluent treatment. At the same time, metals which cannot be precipitated or cannot be completely precipitated in metallic form under the electrolysis conditions set are converted from a higher valency into a lower valency. This is important, for example, if toxic chromium (VI) compounds are present, which are reduced cathodically to form chromium (III) compounds and can then easily be precipitated as hydroxides. In the case of iron (III) compounds in pickling solutions which contain hydrofluoric acid (e.g. stainless steel pickles), the problem exists, for example, of the considerable complexing action of the hydrofluoric acid to form FeF₃ complex. This complex is destroyed and the hydrofluoric acid released by cathodic reduction to form the iron (II) compound. This makes it accessible to known recovery processes, e.g. retardation, and/or presents fewer problems during effluent treatment.

At the anode, predominantly oxygen is developed from chloride-free solutions during the recovery of metals. However, combination processes in which the anode reaction is used to generate or regenerate oxidizing and pickling agents or to completely or partially break down inorganic and/or organic pollutants by oxidation have proven particularly advantageous. In this case, electrolysis can then be carried out in undivided cells if the anodically oxidized compounds cannot be reduced again cathodically, as is the case, for example, when cyanides in metal cyanide solutions are being broken down by oxidation. On the other hand, if reversible redox systems are present, it is generally imperative to use a divided electrolysis cell.

In this context, pollutants which can be broken down at the anode are understood in the broadest sense as meaning inorganic or organic compounds which either themselves have toxic action and therefore must not pass into the effluent or which bond heavy metals to form complexes and as a result not only become more difficult to recover almost completely but also make it impossible to comply with predetermined limit values in effluent treatment or require additional treatment steps, e.g. precipitation with organosulfur compounds, to do so. However, complexing agents play a very important role in particular in the surface treatment of metals, which is the preferred application area of the present invention.

At the anode, in divided or in some cases also in undivided electrolysis cells, inorganic and organic complexing agents, such as for example cyanides, thiocyanates, thiourea, dicarboxylic acids, EDTA, sulfur compounds, such as for example sulfides, sulfur dioxide, thiosulfates and dithionites, nitrogen compounds, such as for example nitrites and amines, inter alia, can be broken down by oxidation. Hydrogen peroxide as an oxidizing agent in pickling solutions can not only be reduced cathodically but also broken down anodically by oxidation to form oxygen.

Completely new possibilities result when the method and apparatus according to the present invention are used for the advantageous regeneration of exhausted pickling solutions based on peroxosulfates. Pickling solutions which contain peroxosulfates of this type are predominantly used to pickle copper and copper alloys. However, they can also be used for the surface treatment of other metals, e.g. of precious metals, of special steels and of special metals, such as for example titanium. The problem with the regeneration of exhausted pickling solutions of this type is that the electrolysis conditions required for recovery of the metals in compact form and the electrolysis conditions required for reoxidation of peroxodisulfates are so different that hitherto it has been impossible to combine them in a single electrolysis cell.

For example, to form peroxodisulfate, inter alia it was previously necessary to use special platinum anodes with a smooth, bright surface and high anode current densities of at least 40 A/dm² and, moreover, anode current concentrations which were as high as possible, in the region of at least 50 A/l, in order on the one hand to suppress the anodic oxygen separation by the high oxygen overvoltages and, on the other hand, to minimize the efficiency-reducing hydrolysis to form peroxomonosulfates. On the other hand, for compact metal precipitation, in standard metal recovery cells with plate-type electrodes a low current density in the range from 1 to 2 A/dm² is required. However, this means that the anode current density would have to be 20 to 40 times the cathode current density in order on the one hand to achieve a sufficiently high current efficiency in the peroxodisulfate formation and on the other hand to allow approximately complete recovery of metals in compact form.

It has hitherto not been possible to combine these contradictory electrolysis conditions in a single electrolysis cell. In the case of the regeneration of peroxodisulfate pickling solutions for copper and copper alloys, for example, the current known prior art is characterized by the following two method variants (Metalloberfläche [Metal Surfaces] 52, 1999, H. 11):

1. The main quantity of the dissolved copper is precipitated in compact form in an upstream metal recovery cell at low current densities, then the peroxodisulfate is reoxidized at high anode current densities in a downstream special peroxodisulfate recycling electrolysis cell.

2. If it is possible to make do without precipitation of copper in compact form, the electrolysis is carried out in a divided persulfate regeneration electrolysis cell at high anode and cathode current densities. The copper is precipitated in powder form at the cathode in the region where hydrogen is developed. This requires complex rinsing and removal processes in order for the copper powder to be discharged as completely as possible and to prevent the cathode spaces from becoming blocked with spongy copper deposits on the cathode.

It has been found that if the method and apparatus for precipitating metal by means of pulsating cathode currents are used, the different electrolysis conditions required in an electrolysis cell are sufficiently close to one another for it to be possible to regenerate peroxosulfate pickling solutions in just one electrolysis cell with a good anode current efficiency and a compact precipitation of metal at the cathode. For this purpose, first of all the dissolved metals are completely or partially precipitated at the cathode from the exhausted peroxodisulfate pickling solutions, and at the same time the unreacted peroxosulfates are reduced to form sulfates in order for the used peroxodisulfates then to be anodically completely or partially regenerated at the anodes coated with platinum or doped diamond and at current densities in the range from 20 to 100 A/dm² and current concentrations of from 50 to 500 A/l.

The pulsating cathode current causes the maximum current density which is to be maintained for compact precipitation of metals to approximate more closely to the high current density required at the anode, both on account of the pulsation effect and on account of the partial redissolution of metal fractions which are precipitated in dendrite form between the pulses by the unreacted peroxosulfates which are present. The inventive division of the anode space into individual anode pockets also makes it possible to maintain the required high anode current concentrations in a simple way. Finally, as a result of using anodes which are coated with doped diamond, it is possible to minimize the current densities required for optimum current efficiencies of the peroxodisulfate formation and in this way to move even closer to the current density required at the cathode.

The pickling solutions regenerated in this way are preferably metered to the pickling bath continuously in a quantity which is such that a pickling rate which is as constant as possible can be maintained. In this case, the peroxodisulfate formation is not limited just to sodium peroxodisulfate which is customarily used as pickling agent. It is also possible for peroxodisulfates of the metals magnesium, zinc, nickel and even iron to be anodically reoxidized, on their own or mixed with sodium peroxodisulfate, and used for pickling purposes. The metal sulfates required are either added to the pickling solution or are formed during the pickling of alloys as a result of an increase in the levels of alloying constituents in the pickling bath, e.g. zinc sulfate in the case of brass pickling.

A common feature of all these metal sulfate/peroxodisulfate mixtures is that the cathodically pretreated pickling solutions preferably have a sulfate concentration (as a sum of the metal sulfate and sulfuric acid concentration) of 2 to 5 mol/l in order to achieve sufficiently high current efficiencies of the peroxodisulfate formation. In addition, substances which are known to increase the potential, e.g. thiocyanates, can be added.

If divided electrolysis cells are used, not only is it possible for the same quantity of the same electrolyte solution to pass through the cathode and anode spaces in succession, but rather it is advantageously also possible for process solutions of different compositions or the same process solutions in different quantitative ratios to be electrolyzed at the anode and cathode. This allows the supply of constituents to be converted at the cathode or anode to be more suitably adjusted with a view to utilizing the available anode or cathode current capacities as fully as possible.

If ion exchange membranes are used as separators, it is also possible, in order to increase the efficiency of the overall process, to exploit the mass transfer through the membranes in addition to the anodic and cathodic reactions presented with a view to achieving optimum process management. For example, if cation exchange membranes are used, a depletion of metal cations form the anolyte can be used to good effect or, if anion exchange membranes are used, a corresponding depletion of anions from the catholyte can be used to good effect. For example, by cathodic treatment of pickling solutions comprising the stable FeF₃ complex, not only is it possible for the hydrofluoric acid bound in complex form to be released by reducing the trivalent iron to the divalent form, but also it is possible for the fluoride ions to be depleted from the catholyte and transferred to the anolyte when anion exchange membranes are used. This results in the option of releasing the fluoride ions bound in complex form from a part-stream of the exhausted fluoride-containing iron (III) pickling solution which is to be removed via the cathode spaces and of these fluoride ions being fed back direct to the main stream of the pickling solution which is to be reoxidized at the anode.

A further possible application for different electrolyte solutions in the cathode and anode spaces consists in blocking the transfer of undesirable types of ions into in each case the other electrode space. For example, metals can be recovered from a chloride-based catholyte solution without undesirable evolution of chlorine at the anode if cation exchange membranes are used as separators and the anode space is fed with a chloride-free “barrier electrolyte”. By way of example, sulfuric acid or a solution which contains sulfates, e.g. sodium sulfate, can be used for this purpose. In this way, not only is it possible to substantially suppress the anodic development of chlorine, but moreover, by transferring metal cations into the anode space, it is also possible for some of the acid released by the cathodic precipitation of metal to be buffered by the transferred metal ions, e.g. sodium ions (e.g. in the case of cathodic precipitation of nickel from chloride-based nickel electrolytes).

The very wide range of possible applications for the invention is to be explained below on the basis of selected application examples.

### EXAMPL 1

An undivided pilot-scale electrolysis cell as shown in FIG. 2a was used to recover metals from process solutions. Its technical data were as follows:

| | |
|---|---|
| Electrode material: | special steel cathode, |
| | titanium anodes, platinum- |
| | coated |
| Cathode surface area: | 2500 cm² (active height of the |
| | cathode cylinder 400 mm, mean |
| | diameter 200 mm) |
| Anode surface area: | 480 cm² (6 anode pockets each |
| | comprising two anode strips |
| | measuring 400 × 10 mm) |
| Rotational speed: | 300 rpm (approx. 3.1 m/s |
| | circumferential speed) |
| Anode-cathode distance: | 40 mm on average |
| Anode pockets: | Approx. 65 mm wide, side walls |
| | approx. 15 mm high. |

Approximately 50 l of electrolyte solution were circulated out of a storage reservoir through the electrolysis cell in batch mode. Electrolysis was carried out at 100 A. Various substantially chloride-free metal salt solutions in sulfate-based electrolytes were used. The metals were precipitated in compact form. The most important data are compiled in Table II.

### EXAMPLE 2

In the electrolysis cell from Example 1, 50 l of an exhausted sulfuric acid-hydrogen peroxide pickling solution for copper were electrolyzed. Starting quantity 58 l with 30 g/ of Cu (approx. 0.48 mol/l), 4.4 g/l of H₂O₂ (approx. 0.13 mol/l) and 115 g/l of free sulfuric acid. Electrolysis was carried out for 17 h at 100 A (current introduction approx. 29.3 Ah/l, cell voltage 3.9 V). The electrolyzed solution still contained 0.3 g/l of copper and 0.1 g/l of H₂O₂. Despite the low residual concentration, the precipitated copper was in compact, securely adhering form. The apparent current efficiency based on the sum of the two cathode reactions of copper precipitation and reduction of hydrogen peroxide turned out to be 116.5%. In actual fact, some of the hydrogen peroxide is oxidized at the anodes, explaining the high apparent current efficiency. Based on the recovery of copper, the current efficiency of 85.8% was still relatively high.

### EXAMPLE 3

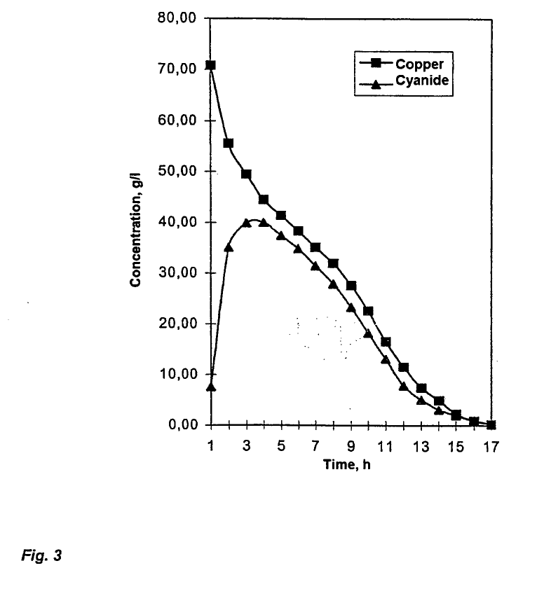

1.5 l of a cyanide-based copper solution were electrolyzed with a current intensity of 16 A for 17 h in a smaller, undivided laboratory scale test cell constructed analogously to Example 1, with four anode strips of 20 cm² made from platinum-coated titanium and a cylinder cathode with an active cathode surface area of 565 cm² (90 mm diameter, 200 mm active cylinder height). The mean cell voltage was 3.8 V. The starting solution contained 71 g/l of copper (bonded in the form of Na₂[Cu(CN)₃]) with an excess of 7.6 g/l of sodium cyanide. FIG. 3 illustrates the relationship between the concentrations of copper and free cyanide and the electrolysis time. Initially, the cathodic precipitation of copper causes more cyanide which is bound in complex form to be released than can be broken down by anodic oxidation. The maximum concentration of free cyanide is only reached after an electrolysis time of 2.5 h. Then, more cyanide is broken down by oxidation than is released at the cathode. Although, based on the copper, the current efficiency is only 16.5% for a residual content of 0.2 g/l, toxic cyanide has been removed from the solution apart from a low residual content of 0.3 g/l.

### EXAMPLE 4

Electrolysis cell from Example 3, 1.5 l of a cyanide-based waste solution from the processing of gold were electrolyzed with a view to substantially breaking down the cyanide by oxidation and recovering the remaining gold. The starting solution contained 21 g/l of free cyanide and approx. 0.8 g of gold. Electrolysis was carried out for 15 h with 16 A at a cell voltage of 3.5 V. The substantially detoxified waste solution then contained only a residual amount of 5 mg/l of gold and 15 mg/l of cyanide.

### EXAMPLE 5

The treatment of an exhausted copper-peroxodisulfate pickling solution took place in an industrial electrolysis cell constructed as shown in FIG. 2a for 500 A with the following technical data: cylinder cathode made from special steel (diameter approx. 400 mm, active height approx. 600 mm). 12 anode pockets distributed uniformly over the circumference and open toward the cathode side. Each pocket was equipped with two platinum-titanium strip anodes measuring 600×8×1.5 mm. The anode-cathode distance was 30 mm, the distance from the side walls of the anode pockets to the cathode was approx. 15 mm. The platinum covering comprised a platinum foil with a thickness of 40 μm applied by HIP welding. The anode current density was 43.4 A/dm², the mean cathode current density was 6.6 A/dm².

105 l of an exhausted pickling solution of the following composition were pumped in a circuit through the cell:

| | | |
|---|---|---|
| Copper | 25.4 | g/l |
| Peroxosulfates (as NaPS) | 20.2 | g/l |
| Sulfuric acid | 210.0 | g/l |
| Sodium sulfate | 238.0 | g/l |

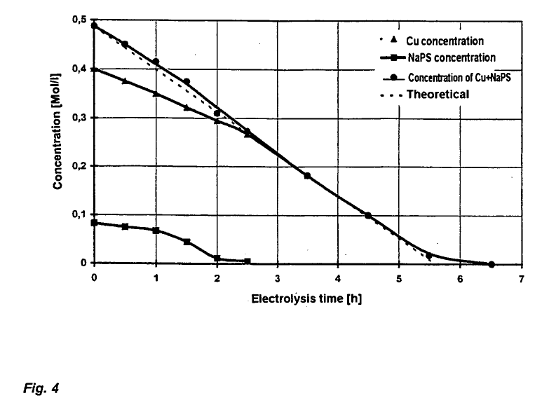

The way in which the molar concentrations of copper and peroxosulfates, detected as sodium peroxodisulfate (NaPS), were related was monitored during the 16.5 hours of electrolysis and is presented in FIG. 4.

This figure plots the drop in the molar concentrations of copper and peroxosulfate individually and cumulatively. The 100% current efficiency rectilinear curve for the sum of the two cathode reactions is also included in the drawing (as a dashed line) for comparison purposes.

After approx. 2.5 hours, all the peroxosulfate has been reduced, and the current efficiency of the copper precipitation is then approximately 100%. Only when the copper content has dropped to approximately 0.01 mol/l does the decrease in Cu content become significantly lower than theory. Only in this range is there any significant coseparation of hydrogen. After an electrolysis time of 6.5 h, the copper concentration has dropped to approx. 0.06 g/l. The cumulative current efficiency for the sum of the two cathode reactions is then still 83.8%.

### EXAMPLE 6

An industrial electrolysis cell for 500 A in accordance with Example 5, but in a divided design as shown in FIG. 2b, was used. For this purpose, the anode pockets were sealed off from the catholyte by cation exchange membranes of the Nafion 450 type. The anolyte flowed through all 12 anode pockets in parallel. The entire anolyte volume (content of all 12 anode pockets) was only 1.5 l so that a high anode current concentration of 333 A/1 was reached. An exhausted peroxodisulfate-copper pickling solution which was pumped in a circuit through the cathode space of the electrolysis cell (batch mode) was electrolyzed. The starting solution had the following composition:

| | | |
|---|---|---|
| Sulfuric acid | 160 | g/l |
| Sodium sulfate | 290 | g/l |
| Sodium peroxodisulfate | 48 | g/l |
| Copper sulfate | 62 | g/l (24.7 g/l of Cu) |

A pickling solution from which the copper had already been cathodically removed in the previous cycle was passed through the anode spaces at a metering rate of on average 11.3 l/h (continuous mode). It had the following composition:

| | | |
|---|---|---|
| Sulfuric acid | 220 | g/l |
| Sodium sulfate | 310 | g/l |
| Sodium peroxodisulfate | 0.0 | g/l |
| Copper sulfate | <0.1 | g/l |

The resulting sum of the sulfate concentration, comprising sulfuric acid and sodium sulfate, was 4.4 mol/l. 0.3 g/l of sodium thiocyanate was dissolved in the anolyte metered in as a potential-increasing electrolysis additive.

Electrolysis was carried out for 4 h 15 min, with the following electrolyte quantities of the following composition:

| | |
|---|---|
| Catholyte | Anolyte |

| | | | | |
|---|---|---|---|---|
| Electrolyte | 48.5 | l | 47.8 | l |
| quantity | | | | |
| Sulfuric acid | 218 | g/l | 162 | g/l |
| Sodium sulfate | 318 | g/l | 226 | g/l |
| Sodium | 0 | g/l | 141 | g/l |
| peroxodisulfate | | | | |
| Copper sulfate | <0.1 | g/l | <0.1 | g/l |

Approximately 98% of the total amount of copper recovered (approx. 1200 g) was precipitated in a compact, smooth form. The concentration profile corresponded to that shown in FIG. 4. Only after the residual copper content dropped below approx. 0.4 g/l was a thin film of a spongy coating formed. Then, in the final phase of the electrolysis, only hydrogen was evolved. During filling for the next batch cycle, this top, spongy copper layer was dissolved again by the peroxosulfate still present, in order to be precipitated again in securely adhering form during the following electrolysis period.

The total quantity of sodium peroxodisulfate formed in one electrolysis cycle was 6,740 g, corresponding to a current efficiency of 71.4%. 1,187 g of copper were precipitated. The mean cell voltage was 6.2 V. Based on the peroxodisulfate formation alone, the result was a specific electrolysis direct current consumption of 1.95 kWh/kg. With this procedure, the entire quantity of peroxosulfate consumed in the pickling process was regenerated (complete regeneration). Since decomposition and entrainment means that significantly more sodium persulfate is consumed in the pickling process than the amount of copper available for cathodic recovery, a significantly higher anode current capacity is required for complete regeneration of the consumed peroxodisulfate than is required for the recovery of copper (including the reduction of the unreacted peroxosulfate). In the case of complete regeneration, this difference is compensated for by the fact that primarily hydrogen is evolved at the cathode at the end of each cycle. After a total of 30 of the electrolysis cycles presented (total electrolysis time approx. 128 h), the cathode was taken out and the copper which had grown on it in compact form, amounting to a total of approx. 36 kg, was removed.

### EXAMPLE 7

Unlike in Example 6, the entire cathode current capacity available was used for the recovery of copper. In this case, however, the anode current capacity is insufficient to reoxidize the entire quantity of persulfate consumed in the pickling process. The difference had to be compensated for by metering in sodium peroxodisulfate (partial regeneration). To do this, using the electrolysis cell in accordance with Example 6, the procedure was as follows. The exhausted pickling solution with the same composition as in Example 8 was metered continuously into the cathode and then, likewise continuously, passed through the downstream anode spaces. The metering rate was adjusted in such a way that the copper concentration in the cathode space did not drop below 1 g/l, in order to avoid precipitation of spongy copper. On average, 15.8 l/h of the pickling solution were metered in (anolyte outlet). 5 g/h of sodium thiocyanate were metered to the catholyte passing from the cathode space into the anode space as a potential-increasing additive. The regenerated pickling solution contained 101 g/l of Na persulfate and still had a residual copper content of 1.1 g/l. Every hour, 371 g of copper were precipitated and 1596 g of sodium peroxodisulfate regenerated (71.9% current efficiency). In actual fact, however, approximately 2500 g/l of sodium peroxodisulfate were consumed in the pickling process (degree of utilization based on the quantity of copper recovered approx. 55%). The differential quantity of 904 g/h was metered in in the form of a concentrate (approx. 2.3 l/h) containing 400 g/l of NaPS. In this way, the entrainment losses of pickling solution from the pickling bath were approximately compensated for at the same time.

### EXAMPLE 8

A peroxodisulfate demetallization solution for defective electroplated copper-nickel coatings was regenerated using the electrolysis cell and the same procedure as in Example 6 (catholyte circuit, anolyte through-flow). The consumed sulfate-based demetallization solution contained, in addition to 160 g/l of free sulfuric acid, 52.7 g/l of copper sulfate (approx. 21 g/l of Cu), 199 g/l of nickel sulfate and 45 g/l of nickel peroxosulfates, calculated as NiS₂O₈ (in total 86 g/l of nickel). The approximately complete recovery of copper (residual content <0.1 g/l) took place in batch mode at the cathode. 50 l of the cathodically treated solution contained 210 g/l of sulfuric acid and 225 g/l of nickel sulfate. After addition of the potential-increasing additive, anodic electrolysis at 500 A was carried out for 4 h 30 min (metering quantity approx. 11.1 l/h). The cell voltage was 6.2 V. The regenerated demetallization solution contained 146 g/l of nickel peroxodisulfate, corresponding to a current efficiency of 69.4%.

Since the nickel is not precipitated in metallic form in the strongly acidic catholyte and nickel is constantly being dissolved, periodically some of the catholyte solution from which copper has been removed has to be discharged from the circuit. The nickel can be recovered therefrom in an undivided electrolysis cell in accordance with Example 1.

### EXAMPLE 9

The platinum-titanium anode strips of the divided electrolysis cell (Examples 6 to 8) were replaced by anode strips made from niobium with a boron-doped diamond coating (12 anode pockets each with two anode strips measuring 600×13 mm). The composition of the starting solution and the test conditions were similar to those used in Example 6 (500 A, catholyte circulated, flow through the anode spaces). On average, 15.5 l/h of the cathodically treated solution were metered into the anode spaces. The anode current density was 27 A/dm², the cell voltage was 6.0 V. Without potential-increasing additives, a regenerate with an NaPS content of 98 g/l was obtained, corresponding to a current efficiency of 68.4% (specific electrical energy consumption approx. 2.0 kWh/kg).

### EXAMPLE 10

An exhausted sulfuric acid-hydrogen peroxide pickling solution for copper contained 33 g/l of copper, 115 g/l of free sulfuric acid, 7.5 g/l of excess hydrogen peroxide and organic stabilizers and complexing agents (1.5 g/l of COD). During the treatment, it was intended not only to recover the copper and to destroy the excess hydrogen peroxide, but also to substantially break down the organic constituents by oxidation. In the divided electrolysis cell from Example 9 with diamond-coated anodes, in each case 50 l of this solution were firstly treated anodically (batch mode) and then treated in the same way cathodically.

Electrolysis was carried out for 3 h at 500 A. During the anodic treatment at the diamond-coated electrodes, not only was the hydrogen peroxide virtually completely broken down, but also the COD content was reduced to approx. 10 mg/l. During the subsequent cathode treatment, the copper content was reduced to approx. 0.1 g/l. A current efficiency of approx. 93%, based on the recovered copper, was achieved.

### EXAMPLE 11

A chemical nickel waste solution contained 5.9 g/l of nickel and large quantities of unreacted hypophosphite, of phosphite and organic complexing agents. The sum of the oxidizable substances was determined as the COD value (COD content approx. 62 g/l). In the same way as in Example 10, 50 l of the solution were initially treated anodically and were then treated cathodically. Circuit electrolysis was carried out anodically for 24 h. In the process, it was possible to reduce the COD value to 2.1 g/l. Most of the organic complexing agents was therefore broken down by oxidation and the hypophosphite or phosphite was oxidized to form phosphate. Based on the reduction in COD, the result was current efficiency of approx. 84%. On account of the transfer of cations, the acid content increased (pH=0) and the nickel content dropped to 3.1 g/l. The solution obtained was metered into a catholyte circuit in a quantity such that the pH was kept in the range from 4 to 5, which is favorable for the precipitation of nickel. The residual nickel content was <0.1 g/l.

### EXAMPLE 12

The divided electrolysis cell in accordance with Example 6 was equipped with 12 new strip anodes measuring 600×60×1.5 mm made from titanium coated with iridium-tantalum mixed oxide. Consequently, the anode pockets were utilized over the entire available width, and the anode current density was as a result reduced to 11.6 A/dm² at 500 A maximum current loading.

The following procedure was used to regenerate an iron (III) chloride etching solution for copper materials: the catholyte was circulated from a recirculation vessel through the cathode space of the cell. A part-stream of the exhausted etching solution, which was greatly enriched with copper, was continuously metered into this circuit and the overflow of the catholyte with the steady concentrations which are established (copper substantially depleted, iron (III) chloride reduced to iron (II) chloride) was passed into the anode spaces connected hydrodynamically in parallel. In addition, a further part-stream of the exhausted etching solution was metered directly into the anode spaces.

The following concentration and quantitative ratios were set or measured: 5.7 l/h of pickling solution were metered into the catholyte circuit, and 34.3 l/h of pickling solution, plus 6.4 l/h of overflow from the catholyte circulation (approx. 0.7 l/h transfer of water through the membrane) were metered directly into the anode spaces. Approx. 40 l/h of regenerated etching solution emerged from the anode spaces. The following concentrations were established in the steady operating state:

| | | |
|---|---|---|
| Exhaused | | Regenerated |
| etching | Catholyte | etching |
| solution | outlet | solution |

| g/l | Mol/l | g/l | Mol/l | g/l | Mol/l |
|---|---|---|---|---|---|
| Copper | | | | | |
| as Cu²⁺ | | | | | |
| 60.0 | 0.945 | 0.079 | 51.0 | 0.803 | |
| | 5.0 | | | | |
| Iron as | | | | | |
| Fe³⁺ | | | | | |
| 63.0 | 1.129 | 5.2 | 0.093 | 79.0 | 1.416 |
| Iron as | | | | | |
| Fe²⁺ | | | | | |
| 27.0 | 0.454 | 80.2 | 1.437 | 11.0 | 0.197 |
| free HCl | | | | | |
| 20.0 | 0.548 | 28.0 | 0.767 | 20.0 | 0.548 |

In total, on average 363 g/h of copper were precipitated at the cathode (approx. 61% current efficiency), and the total quantity of iron (III) chloride consumed in the pickling bath and reduced in the cathode space, of 979 g/l of Fe³⁺, was reoxidized (anode current efficiency approx. 94%).

### EXAMPLE 13

A consumed chloride-based nickel bath (Watts bath) with a nickel content of 65 g/l and a total chloride content of 37 g/l Cl⁻ was circulated in batch mode through the cathode space of the electrolysis cell from Example 12 with anodes coated with Ir—Ta mixed oxide. The pH was buffered to 4-5 by addition of sodium hydroxide solution. The anolyte used was a waste solution of sodium sulfate in sulfuric acid containing approx. 200 g/l of which was likewise circulated via the anode spaces in batch mode. The nickel was depleted at the cathode down to a residual level of approx. 0.1 g/l. Since Na⁺ ions are transferred through the cation exchange membrane, the acid released by the nickel precipitation is neutralized, and as a result the pH was kept within the range indicated. The mean current efficiency of the nickel precipitation was approx. 72%. Predominantly oxygen was separated off at the anode. Only approx. 0.2% of the chloride passed into the anode space in the opposite direction to the migration rate of chloride ions on account of back-diffusion, and consequently it was only possible for small quantities of chlorine to evolve at the anode. It was easy to remove these small quantities of chlorine by means of an alkaline off-gas scrub.

### EXAMPL 14

A consumed sulfuric acid-iron (III) sulfate pickling solution for copper materials was regenerated by means of the electrolysis cell equipped in accordance with Example 12. For this purpose, a part-stream of the exhausted pickling solution amounting to 22 l/h was fed firstly via the cathode space and then, after cathodic precipitation of copper, to the anode spaces of the cell. A further, larger part-stream of the exhausted pickling solution amounting to 158 l/h was metered directly to the anode spaces. The regenerated solution amounting to in total 180 l/h was fed back to the pickling bath. The compositions of the solutions supplied and discharged were as follows:

| | Exhausted | | |
|---|---|---|---|
| | pickling | Catholyte | Anolyte |
| | solution | outlet in | outlet in |
| | in g/l | g/l | g/l |
| Sulfuric | 260.0 | 296.0 | 264.0 |
| acid | | | |
| Copper | 26.8 | 2.8 | 23.9 |
| Iron as | 4.0 | 0.0 | 8.6 |
| Fe³⁺ | | | |
| Iron as | 6.0 | 10.0 | 1.4 |
| Fe²⁺ | | | |

The total quantity of copper recovered was 553 g/h (current efficiency approx. 93%). The reoxidized iron (III) sulfate is sufficient to redissolve approximately the same quantity of copper in the pickling bath.

### EXAMPLE 15

To recover platinum from platinum-containing materials (comminuted graphite electrode material with a coating of platinum black, approx. 1.6% Pt), the procedure was as follows: 1000 l of an extraction solution containing 200 g/l of sulfuric acid and approx. 30 g/l of hydrochloric acid were circulated via the anode spaces of the electrolysis cell (equipped in accordance with Example 12) and via a stirred vessel containing 100 kg of the starting material to be extracted. The current intensity was set in such a way that the free chlorine content, in dissolved form, did not exceed approx. 2 g/l (the current intensity was reduced in steps from an initial level of 500 A to 100 A). Platinum was dissolved as hexachloroplatinate. The platinum content was monitored and the electrolysis was ended after approx. 15 h, after it was no longer possible to detect any growth. The final concentration was 1.6 g/l of platinum. After the solid had been separated off, the platinum-containing solution was used as catholyte in the next cycle and was circulated via the cathode space of the cell. The platinum was precipitated predominantly in compact form. The platinum which was precipitated in powder form just at the end of the cycle was initially redissolved during filling with the extraction solution of the next cycle, still containing free chlorine, and was then precipitated again (in compact form) after the electrolysis current had been switched on. 1530 g of platinum with a content of 96% were recovered.

### EXAMPLE 16

To regenerate a special steel pickle based on iron (III) sulfate-hydrofluoric acid, the electrolysis cell in accordance with Example 12 was equipped with anion exchange membranes of the Neosepta ACS type. A consumed pickling solution had the following steady composition (for free acids, metals calculated as sulfates, although actually in part present as fluoro complexes):

| | |
|---|---|
| Iron as Fe³⁺ | 0.88 mol/l (approx. 49 g/l) |
| Iron as Fe²⁺ | 1.42 mol/l (approx. 79 g/l) |
| Chromium as Cr³⁺ | 0.60 mol/l (approx. 31 g/l) |
| Nickel as Ni²⁺ | 0.28 mol/l (approx. 16 g/l) |
| Sulfuric acid | 0.04 mol/l (approx. 4 g/l) |
| Hydrofluoric acid | 2.00 mol/l (approx. 40 g/l) |

The electrolysis cell was fed with a total of 11.9 l/h of the pickling solution. Of this, 9.5 l/h were fed direct to the anode spaces, and 2.4 l/h were metered into a steady catholyte circulation.

Via the anion exchange membranes, the acids which were free and released by cathodic reduction of the iron (III) ions or by the cathodic precipitation of metal were depleted and transferred into the anolyte. A pH of 3-4, which is required for the precipitation of an iron-nickel-chromium alloy, was established in the catholyte circuit. The catholyte, with a greatly depleted content of the metals, was likewise passed through the anode spaces. Approx. 271 g/h of a special steel alloy of approximately the composition present in the pickling bath were precipitated (approx. 70% current efficiency). At the anode, the consumed and cathodically reduced iron was reoxidized to form the iron (III) sulfate. The regenerated pickling solution had the following composition:

| | |
|---|---|
| Iron as Fe³⁺ | 1.80 mol/l (approx. 49 g/l) |
| Iron as Fe²⁺ | 0.20 mol/l (approx. 79 g/l) |
| Chromium as Cr³⁺ | 0.52 mol/l (approx. 27 g/l) |
| Nickel as Ni²⁺ | 0.24 mol/l (approx. 14 g/l) |
| Sulfuric acid | 0.50 mol/l (approx. 50 g/l) |
| Hydrofluoric acid | 2.00 mol/l (approx. 40 g/l) |

TABLE I
Apparent pulsation frequencies of the cathode current

| | |
|---|---|
| Distance | |
| between | |
| the anode | Apparent pulse frequency in s⁻¹ for various |
| pockets | circumferential speeds in m/s |

| in mm | 2 | 4 | 6 | 8 |
|---|---|---|---|---|
| 40 | 50.0 | 100.0 | 150.0 | 200.0 |
| 50 | 40.0 | 80.0 | 120.0 | 160.0 |
| 60 | 33.3 | 66.7 | 100.0 | 133.3 |
| 80 | 25.0 | 50.0 | 75.0 | 100.0 |
| 100 | 20.0 | 40.0 | 60.0 | 80.0 |
| 133 | 15.0 | 30.0 | 45.0 | 60.0 |

TABLE II

| | Starting | | Final | |
|---|---|---|---|---|
| Precipi- | concen- | | concen- | Current |
| tated | tration | | tration | efficiency |
| metal | in g/l | Ph | in g/l | in % |
| Copper | 30 | 1-2 | 0.05 | 98 |
| Nickel | 50 | 3-5 | 0.1 | 95 |
| Iron | 40 | 4-5 | 0.5 | 96 |
| Tin | 20 | 1-2 | 0.5 | 86 |
| Silver | 10 | 1-2 | 0.01 | 99 |

1. A method for recovering metals from process solutions and effluents by means of pulsating cathode currents, also in combination with anodic coproduction processes, by electrolysis by means of direct current in an electrolysis cell which is equipped with cathodes and anodes and is undivided or divided by separators, characterized in that the pulsating cathode currents are generated by the anodes being divided into strips with a width of 2 to 100 mm and, individually or combined in groups, being arranged in a stationary position parallel or concentrically to the cathode surface, while the undivided cathode surface is guided past at a rate of 1 to 10 m/s in a direction perpendicular to the longitudinal extent of the anode strips, the distance between the side walls of two adjacent individual anode strips or the groups of anode strips amounting to at least 1.5 times the perpendicular distance between the center of the anode strips or the group of anode strips and the cathode.

2. The method as claimed in claim 1, characterized in that considerably greater distances are set between some anode strips or some groups of anode strips than between the others.

3. The method as claimed in claims 1 and 2, characterized in that internals used as current diaphragms and/or flow breakers are arranged in the spaces between the anode strips or the groups of anode strips.

4. An apparatus for carrying out the method as claimed in claims 1 to 3, comprising:
an electrolyte vessel 1,
at least one rotating cylinder cathode 5 arranged in the electrolyte vessel,
at least one drive 4 which is arranged outside the vessel and the shaft of which is directly connected to the cylinder cathode 5,
one or more sliding contacts 21 for transmitting the electrolysis current to the rotating cylinder cathode,
anodes 6 arranged concentrically around the cylinder cathode,
in the case of divided cells, in addition separators 13 arranged between the anodes and the cylinder cathode,
characterized in that the anodes are formed from perpendicularly arranged anode strips 6 with a width of 2 to 100 mm, which are arranged in anode pockets 8, 11 individually or combined in groups, the distance between the individual anode pockets amounting to at least 1.5 times the perpendicular distance between the anode strips and the cathode and their side walls extending over at least 25% of the perpendicular distance between anode strips and cathode and simultaneously serving as potential-shielding current diaphragms and turbulence-increasing flow breakers.

5. The apparatus as claimed in claim 4, characterized in that the anode pockets 8, in the case of divided cells, are equipped with separators 13 and separate feeds and discharges for the anolyte 16, 18.

6. The apparatus as claimed in claims 4 and 5, characterized in that the anode pockets 8, 11 are distributed unevenly around the cylinder cathode 5, so that the distances between individual anode pockets amount to a multiple of the distances between the other anode pockets.

7. The apparatus as claimed in claims 4 to 6, characterized in that the drive 4 of the cylinder cathode 5 is arranged inside the electrolyte vessel 1 in a space which is separated off in a liquid-tight and gas-tight manner.

8. The apparatus as claimed in claims 4 to 7, characterized in that a cooler 12 is arranged inside the electrolyte vessel 1.

9. The apparatus as claimed in claims 4 to 8, characterized in that the rotational speed of the cylinder cathode 5 can be varied by using a frequency-controlled drive 4.

10. The apparatus as claimed in claims 4 to 8, characterized in that the cylinder cathode 5 consists of special steel.

11. The apparatus as claimed in claims 4 to 10, characterized in that the cylinder cathode 5 is of slightly conical design.

12. The apparatus as claimed in claims 4 to 11, characterized in that the anode strips 9 consist of one of the valve metals titanium, niobium, tantalum or zirconium coated with platinum, with precious metal oxides or with doped diamond.

13. The apparatus as claimed in claims 4 to 12, characterized by the use of ion exchange membranes or microporous plastic films as separators 13.

14. The apparatus as claimed in claims 4 to 13, characterized in that in the case of divided cells a plurality of the anode pockets 11 equipped with separators 13 are hydrodynamically connected in series.

15. The apparatus as claimed in claims 4 to 14, characterized in that the electrode spacing is kept constant, in the case of a conical cylinder cathode 5, by the fact that the anodes or anode pockets are arranged in the electrolyte vessel with an inclination which is matched to the cone of the cylinder cathode.

16. The use of the method and of the apparatus as claimed in claims 1 to 15 for metal recovery by means of pulsating cathode currents using divided or undivided electrolysis cells, characterized in that at the cathode
one or more metals from the group consisting of: copper, nickel, iron, cobalt, zinc, cadmium, chromium, lead, tin, rhenium, silver, gold, platinum and other precious metals are precipitated in compact form and recovered at mean cathode current densities of 2 to 10 A/dm² in batch or continuous operation with a depletion level down to as little as 10 mg/l,
oxidizing agents peroxosulfate or hydrogen peroxide which are additionally present are cathodically reduced,
metal compounds with a relatively high valency which are additionally present are converted into metal compounds with a lower valency of the metals,
oxygen being formed at the anodes and/or
oxidizing and pickling agents being generated or regenerated,
inorganic and/or organic pollutants being completely or partially broken down by oxidation.

17. The use as claimed in claim 16, characterized in that, from the exhausted peroxodisulfate pickling solutions, first of all the dissolved metals are completely or partially precipitated cathodically, and at the same time unconverted peroxosulfates are reduced, then the used peroxodisulfates are completely or partially anodically reoxidized at anodes coated with platinum or doped diamond and at current densities in the range from 20 to 100 A/dm² and current concentrations of from 50 to 500 A/l, and the pickling solutions which have been regenerated in this way are fed back to the pickling bath.

18. The use as claimed in claims 16 and 17, characterized in that in the cathodically treated pickling solution the sulfate concentration as the sum of the metal sulfate and sulfuric acid concentration is 2 to 5 mol/l, the sulfates used being those of sodium, magnesium, zinc, nickel and iron, in each case alone or in the form of mixtures.

19. The use as claimed in claim 16, characterized in that the pollutants broken down by oxidation are cyanides and cyano compounds, organic complexing agents, sulfides, thiosulfates, sulfites, organochlorine compounds, nitrites and amines.

20. The use as claimed in claim 16, characterized in that in the case of divided electrolysis cells the anode and cathode spaces are fed with different process solutions, and the mass transfer through the cation/anion exchange membranes is deliberately utilized to increase and reduce the levels of cations/anions and/or to block the transfer of anions/cations into the other electrode space in each case.

21. The use as claimed in claims 16 and 20, characterized in that a process solution which contains metal chlorides is electrolyzed in the cathode space of an electrolysis cell divided by means of cation exchange membranes, while the anode spaces are fed with sulfuric acid or another chloride-free solution.
